(19) United States
(12) Patent Application Publication
(10) Pub. No.: US 2019/0111938 A1
(43) Pub. Date: Apr. 18, 2019

(54) DEVICE MANAGEMENT IN A VEHICLE

(71) Applicant: International Business Machines Corporation, Armonk, NY (US)

(72) Inventors: Hao Chen, Beijing (CN); Ya Bin Dang, Beijing (CN); Qi Cheng Li, Beijing (CN); Shao Chun Li, Beijing (CN); Li Jun Mei, Beijing (CN); Jian Wang, Beijing (CN); Yi Peng Yu, Beijing (CN); Xin Zhou, Beijing (CN)

(21) Appl. No.: 15/782,312

(22) Filed: Oct. 12, 2017

(51) Int. Cl. B60W 50/08; H04M 1/725; B60N 2/02; H04L 29/08; B60R 16/037

(52) U.S. Cl. CPC B60W 50/085; H04M 1/72525; B60K 2350/357; H04L 67/12; B60R 16/037; B60N 2/0244

(57) ABSTRACT

A method, a computer program product, and a computer system for managing a device in a vehicle. The computer system obtains a first configuration of a first device of a first vehicle, wherein the first configuration is set by a user of the first vehicle and the first configuration meets a driving habit of the user. The computer system generates an ergonomic model for the user based on the first configuration. The computer system determines a second configuration of a second device of a second vehicle based on the ergonomic model.

### BACKGROUND

The present invention relates generally to device management, and more particularly to implementations of the present invention relate to methods, systems, and computer program products for managing a device in a vehicle.

The development of the modern automobile industry provides a lot of convenience for people's lives. For example, one family may own multiple cars, and thus a family member needs to adjust the devices (for example, the car seat, the steering wheel, the rearview mirror, and the like) to appropriate positions so as to adapt to his/her personal driving habit before driving a different car. As another example, for a user of a car rental, the user also needs to adjust the various devices in the rented car. How to manage and adjust the devices in the vehicle in a more convenient and efficient manner becomes a focus in the art.

### SUMMARY

In one aspect, a computer-implemented method for managing a device in a vehicle is provided. The computer-implemented method includes obtaining a first configuration of a first device of a first vehicle, wherein the first configuration is set by a user of the first vehicle and the first configuration meets a driving habit of the user. The computer-implemented method further includes generating an ergonomic model for the user based on the first configuration. The computer-implemented method further includes determining a second configuration of a second device of a second vehicle based on the ergonomic model.

In another aspect, a computer program product for managing a device in a vehicle is provided. The computer program product comprises a computer readable storage medium having program code embodied therewith. The program code is executable to obtain a first configuration of a first device of a first vehicle, wherein the first configuration is set by a user of the first vehicle and the first configuration meets a driving habit of the user. The program code is further executable to generate an ergonomic model for the user based on the first configuration. The program code is further executable to determine a second configuration of a second device of a second vehicle based on the ergonomic model.

In yet another aspect, a computer system for managing a device in a vehicle is provided. The computer system comprises one or more processors, one or more computer readable tangible storage devices, and program instructions stored on at least one of the one or more computer readable tangible storage devices for execution by at least one of the one or more processors. The program instructions are executable to: obtain a first configuration of a first device of a first vehicle, wherein the first configuration is set by a user of the first vehicle and the first configuration meets a driving habit of the user; generate an ergonomic model for the user based on the first configuration; and determine a second configuration of a second device of a second vehicle based on the ergonomic model.

### BRIEF DESCRIPTION OF THE SEVERAL VIEWS OF THE DRAWINGS

FIG. 1 depicts a cloud computing node, in accordance with an embodiment of the present invention.

FIG. 2 depicts a cloud computing environment according to an embodiment of the present invention, in accordance with one embodiment of the present invention.

FIG. 3 depicts abstraction model layers, in accordance with an embodiment of the present invention.

FIG. 4 depicts a diagram for managing a device in a vehicle based on an ergonomic model for a user of the vehicle, in accordance with an embodiment of the present invention.

FIG. 5 depicts a flowchart of a method for managing a device in a vehicle based on ergonomic model for a user of the vehicle, in accordance with an embodiment of the present invention.

FIG. 6 depicts a diagram for generating an ergonomic model for a user of a vehicle, in accordance with an embodiment of the present invention.

FIG. 7 depicts a diagram for generating an ergonomic model for a user based on a comparison of a parameter and a specification, in accordance with an embodiment of the present invention.

FIG. 8 depicts a diagram for updating an ergonomic model for a user, in accordance with an embodiment of the present invention.

FIG. 9 depicts a diagram for determining a configuration of a car seat that is equipped in another vehicle based on an ergonomic model for a user, in accordance with an embodiment of the present invention.

FIG. 10 depicts a diagram of a device management unit for managing a device in a vehicle based on ergonomic model for a user, in accordance with an embodiment of the present invention.

### DETAILED DESCRIPTION

Some embodiments will be described in more detail with reference to the accompanying drawings, in which the embodiments of the present invention have been illustrated. However, the present invention can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, the embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

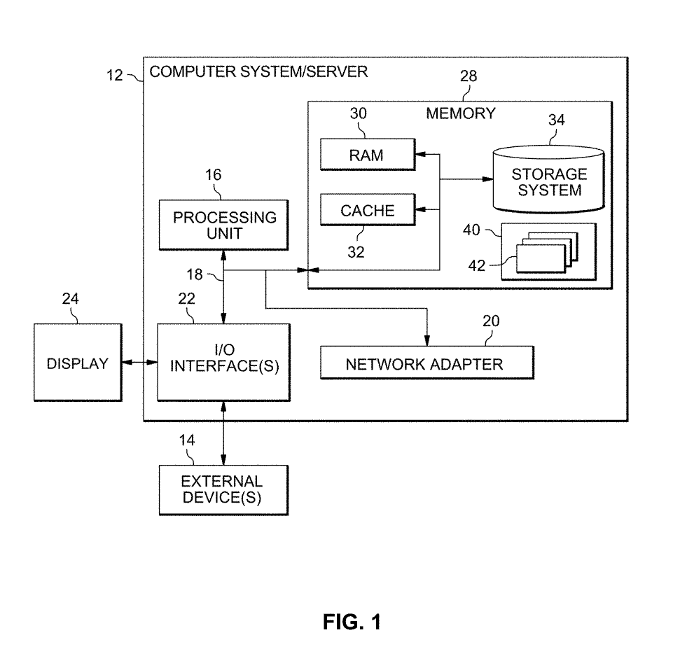

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

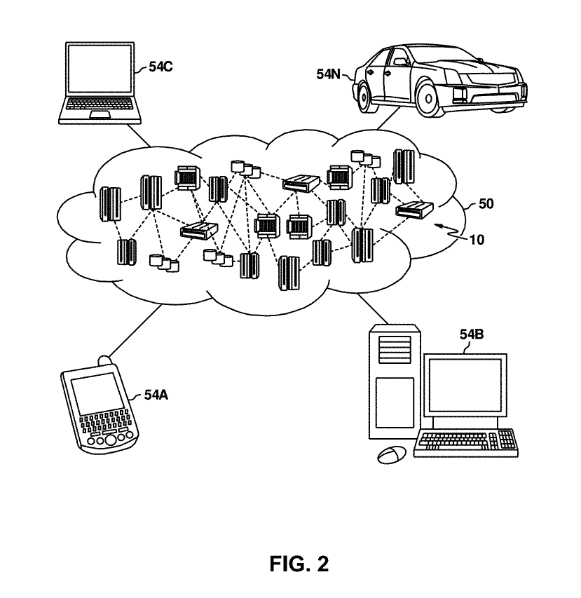

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

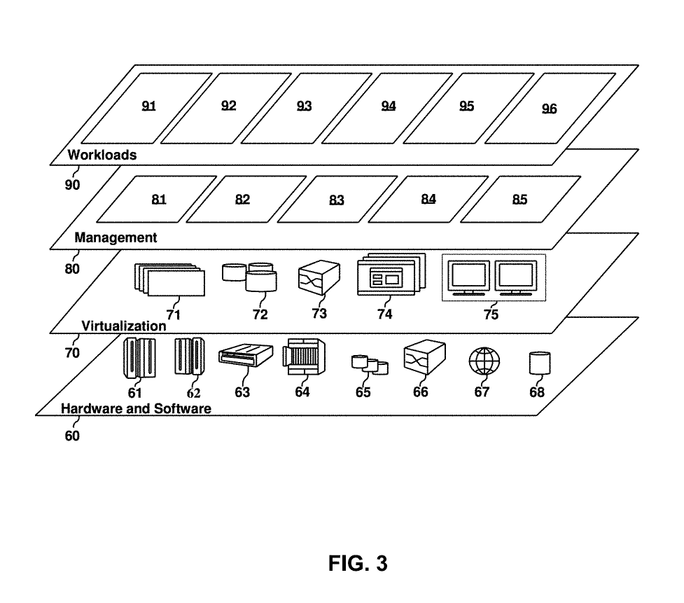

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and management processing 96. The management processing 96 may implement the solution for managing a device in a vehicle.

For the purpose of description, detailed description will be presented to various implementations of the present invention in the cloud environment. The disclosed implementations may be achieved in a computing node in the cloud computing environment. The computing node may be for example a computing device equipped in a vehicle, a mobile phone owned by a user of the vehicle, or another computing device as long as the computing device may access the related data for managing the device in the vehicle.

In the context of the present invention, a vehicle may refer to any type of automobiles, including but not limited to a car, a jeep, a sport utility vehicle, a truck, and so on. The device in the vehicle may refer to any type of devices that are equipped in the vehicle such as a car seat, a steering wheel, a rearview mirror, a left mirror, a right mirror, a headrest, a safety belt, a car lamp, an air condition device, a multimedia device, a navigation device, and the like.

Some approaches have been proposed to manage a device in a vehicle. In one approach, configurations of the device (such as the car seat in the car) may be recorded for a certain person. For example, for a car owned by a family, each of the family members may set the position of the car seat according to his/her driving habit and store the corresponding position. When the family member enters into the car, he/she may simply adjust the car seat according to the previously stored position instead of adjusting the car seat manually. In another approach, configurations of the devices in the car may be automatically adjusted according to the environment and the user's situation in the car.

However, these approaches can only manage and adjust the devices in a single vehicle and cannot be utilized for managing devices in a new vehicle. Even if the configurations may be transmitted to the new vehicle, the previously stored configurations may become useless in the new vehicle due to the difference between the brands and types of the two vehicles.

In order to at least partially solve the above and other potential problems, a new method, systems, and computer program products for managing a device in a vehicle are disclosed herein. According to implementations of the present invention, a method is disclosed. In the method, a first configuration of a first device that is equipped in a first vehicle may be obtained, where the first configuration is set by a user of the first vehicle so as to meet a driving habit of the user. An ergonomic model for the user may be generated based on the obtained first configuration. A second configuration of a second device that is equipped in a second vehicle may be determined based on the generated ergonomic model.

In the context of the present invention, the implementations are described by taking the car seat as an example device in the vehicle for the purpose of illustration instead of limitation. It is to be understood that the device may include but not be limited to a car seat, a steering wheel, a rearview mirror, a left mirror, a right mirror, a headrest, a safety belt, a car lamp, an air condition device, a multimedia device, and a navigation device. Further, the position of the device is just an example of the configuration. In another implementation, the configuration may include but not limited to the position of the device in a 3-dimension space, the orientation of the device, and other parameters such as the target temperature and humidity of the air condition.

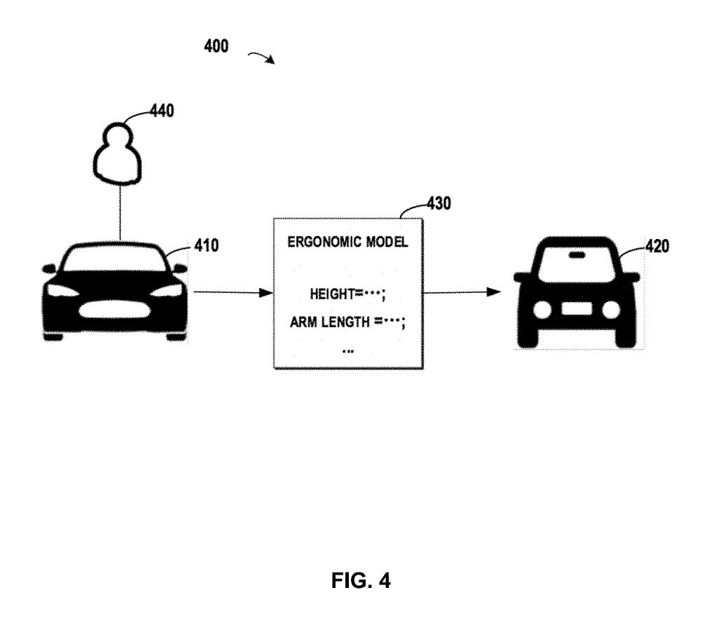

FIG. 4 depicts a diagram for managing a device in a vehicle based on an ergonomic model for a user of the vehicle, in accordance with an embodiment of the present invention. In FIG. 4, a first vehicle 410 may be a car and a second device 420 may be a jeep. A user 440 may set the seat of the first vehicle 410 to an appropriate position according to his/her height, the length of the legs and other driving habit. In the implementation, as the first configuration (such as the position) of the seat in the first vehicle is set by the user, this position may meet the body shape of the user 440. Specifically, the position of the seat may be fit for the user's ergonomic parameters (such as the height and the length of the legs), which in turn to meet the user's driving habit.

Although the above paragraph describes the implementation by taking a real car as an example of the first vehicle 410, in another implementation, the first vehicle 410 may be a simulator that simulates the driving environment of a real car. For example, the simulator may be provided at a car rental office, and the user may first enter into the simulator and adjust the configuration of the seat and other devices according to his/her driving habit. At this point, the obtained configuration may be used as the base for generating the ergonomic model.

At this point, the position may reflect the ergonomic parameters of the user 440 and thus may be used as a source from which an ergonomic model 430 may be generated for the user 440. When the user 440 changes to the second vehicle 420, although the dimension of the seat and other devices may be different from those of the first vehicle 410, the generated ergonomic model 430 may be used to determining an appropriate position that fits for the user's driving habit.

With the implementation, as the ergonomic model 430 is generated based on the user's manual configuration of the seat in the first vehicle 410, thereby the ergonomic model is specific to the user's ergonomic parameters. When the user 440 changes to the second vehicle 420, the position of the seat may be automatically determined based on the ergonomic model 430. In one situation, the ergonomic model 430 may be generated based on the position of the seat in the car that the user 440 drives daily. When the user 440 is travelling and rents different vehicles in different places, the ergonomic model 430 may be facilitated in determining an appropriate position of the seats in these rented vehicles. At this time, the seat in the rented vehicle may be set to the positon that satisfying the driving habit of the user 440, even before the user 440 enters into the rented vehicle.

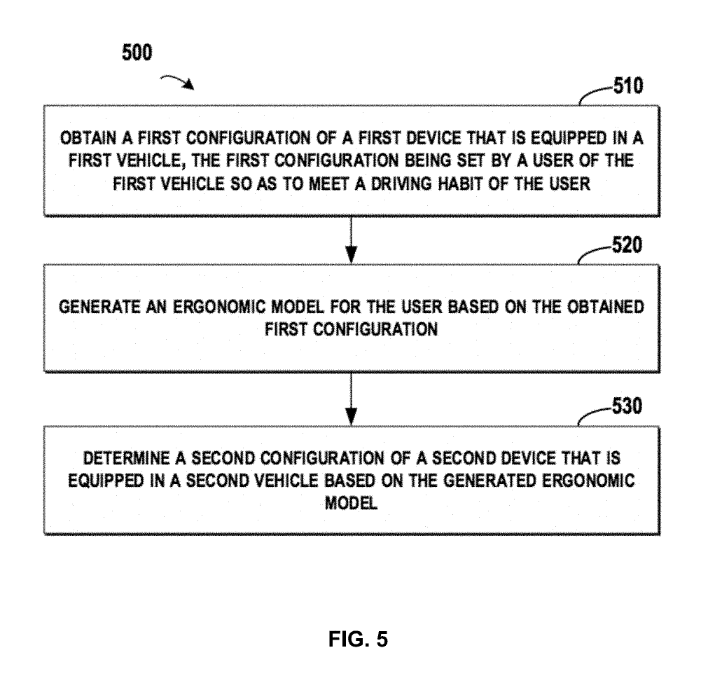

FIG. 5 depicts a flowchart of a method 500 for managing a device in a vehicle based on ergonomic model for a user of the vehicle, in accordance with an embodiment of the present invention. As shown in FIG. 5, a first configuration of a first device 410 that is equipped in a first vehicle 410 is obtained (step 510), where the first configuration is set by a user 440 of the first vehicle 410 so as to meet a driving habit of the user 440.

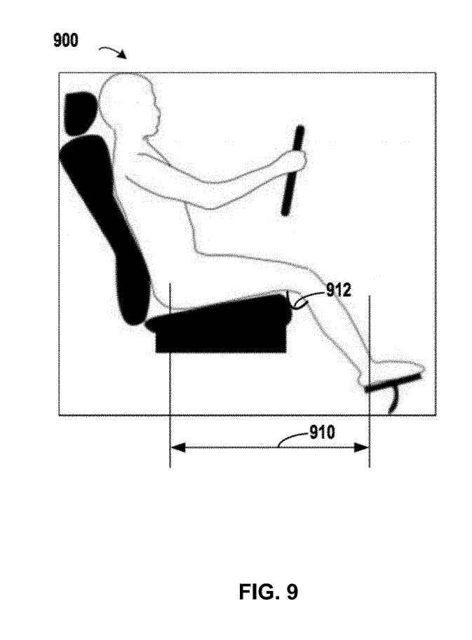

Here, the first configuration may include at least one parameter related to the device. In the example of setting the position of the seat, the first configuration may include a position in the 3-dimension space, a size of the seat, the angle of the backrest of the seat, and other parameters such as a normal angle 912 (shown in FIG. 9) at the knee. In another example for adjusting the rearview mirror in the vehicle, the first configuration may include the position of the mirror as well as an orientation of the mirror in a 3-dimension space.

With the developments of the automobile industry, configuration of the device may be known by a controlling system of the vehicle. For example, On-Board Diagnostic (OBD) systems are provided in the vehicles by more and more automobile manufactures. The OBD system may collect various states of the devices in the vehicle for monitoring the running state of the vehicle. In the OBD system, the respective states of the respective devices may be collected by dedicated sensors.

Regarding the position of the seat, the state of the motor for moving the seat may be collected so as to determining the configuration of the seat. In another example, regarding the rearview mirror, the state of the motor for moving and rotating the mirror may be collected so as to determining the configuration of the mirror. At this point, each of the at least one first parameter included in the first configuration may be collected by the corresponding sensor(s) equipped in the first vehicle 410. In a situation of an old vehicle without an OBD system, additional sensors may be equipped in the vehicle for collecting the at least one parameter included in the first configuration. Alternatively, the parameter(s) included in the first configuration may be obtained in another manner, for example, the parameter(s) may be input by the user 440 or read from another source.

In the implementations of the present invention, the ergonomic model 430 may be generated based on the collected parameter(s). Here, the ergonomic model 430 may be defined in various ways according to the specific requirements. Usually, the body shape of the user 440 is heavily depended on the height of the user 440. Accordingly, in a simple example, the ergonomic model 430 may include the height of the user 440. Alternatively, in another example, the ergonomic model 420 may further include any of the parameters such as length of the leg, the length of the arm, and so on. Based on a statistics of the proportion of human body, other parameters may be evaluated from the height. An example statistics of proportions of human body for the male is illustrated below in Table 1. Other example statistics may be provided for the female, and details are omitted hereinafter. As shown in the first line in Table 1, the data indicates a proportion of the length of the leg and the height, if the height of the user 440 is 180 cm, then the length of the leg=0.426*180≈77 cm.

TABLE 1
Example Statistics

| | |
|---|---|
| 1 | The length of the leg = 0.426 * the height. |
| 2 | The length of the thigh = 0.206 * the height. |
| 3 | The length of the shank = 0.22 * the height. |
| 4 | The length of the arm = 0.346 * the height. |
| 5 | The length of the upper arm = 0.208 * the height. |
| 6 | The length of the lower arm = 0.138 * the height. |
| . . . | . . . |

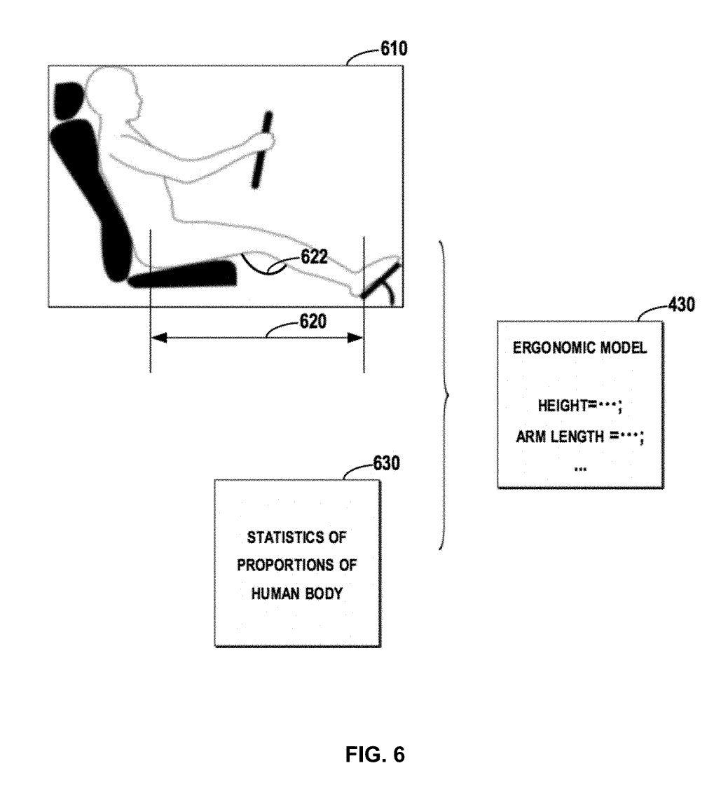

In the implementations of the present invention, at step 520, the ergonomic model 430 is generated for the user 440 based on the obtained first configuration. Reference will be made to FIG. 6 to describe details for generating the ergonomic model 430 based on the position of the seat in the first vehicle 410. FIG. 6 depicts a diagram 600 for generating an ergonomic model for a user of a vehicle, in accordance with an embodiment of the present invention. The reference number 610 in FIG. 6 illustrates a situation where the user 440 is sitting in the first vehicle 410 of a car. Among various types of vehicles, the automobile chassis of the car is relatively low and the posture of the user 440 may be a relative flat shape, where the angle 622 at the knee is large (for example, 135°).

In the above example of the seat, if the position of the seat is defined by a distance 620 between the end of the seat and the front of the first vehicle 410, based on the procedure as described in the preceding paragraphs, the distance 620 may be obtained from the OBD system of the first vehicle 410. In a simplified manner, the distance 620 may be considered as the length of the leg for the user 440. A reference number 630 in FIG. 6 illustrates an example statistics of proportions of human body. For example, the example statistics may be stored in a data structure as illustrated in Table 1. According to the illustrated statistics, the height of the user 440 may be determined from the distance 620 (which is considered as the length of the leg for the user 440). Alternatively, in a more accurate manner, the lengths of the thigh and the shank, together with the angle 622 at the knee may be used to estimate the length of the leg.

In the implementations of the present invention, as the designs of various types of vehicles are different, the specification of the first vehicle 410 may be considered in determining the ergonomic model 430 for the user 440. Here, a first specification that specifies a coordinate system of the first vehicle 410 may be obtained, and then the ergonomic model 430 may be determined based on a comparison of the collected at least one first parameter and the first specification.

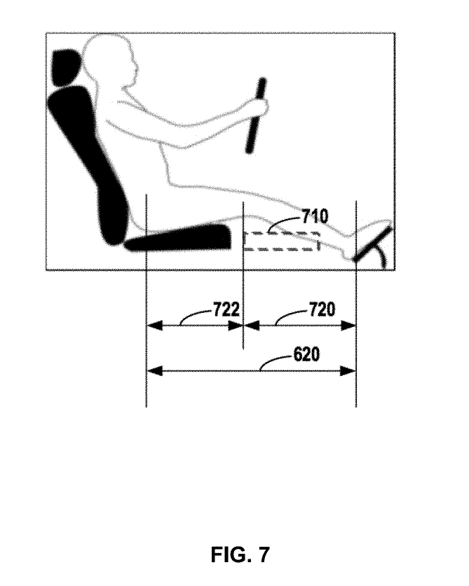

It is to be understood that, the specification of the vehicle may be obtained from the automobile manufactures, for example, from a guide of the vehicle. Usually, the specification may define a coordinate system for the vehicle, and provide measurements for each of the devices in the coordinate system. For example, the coordinate system may provide an original position of the seat, the rearview mirror, and other devices. Reference will be made to FIG. 7 for details of how to generate the ergonomic model 430.

FIG. 7 depicts a diagram 700 for generating an ergonomic model 430 of a user 440 based on a comparison of the collected first parameter and the first specification, in accordance with an embodiment of the present invention. According to FIG. 7, an original position 710 (as illustrated by the dash block 710 in FIG. 7) of the seat may be obtained from the coordinate system for the vehicle 410. Further, if the position of the seat is represented by an offset 722 of the seat from the original position 710, then in a simplified manner, the total distance 620 may be a sum of the offset 722 and the distance 720. Here, the distance 720 may indicate a horizontal distance between the original position 710 and the brake of the first vehicle 410.

It is to be understood that the above paragraphs just describe a simplified example of determination of the length of the leg. In another example, the thickness of the body of the user 440, and the angle at the knee may be considered to determine the length of the leg in a more accurate manner. Further, based on the length of the leg, the height of the user 440 may be estimated, and in turn other parameters (such as the length of the arm, and so on) included in the ergonomic model 430 may be determined. In one example, if the length of the leg is 77 cm, based on the statistics in Table 1, the height of the user may be 77/0.426≈180 cm, and the length of the arm is 180*0.346≈62 cm.

Sometimes, the ergonomic model 430 that is generated based on the configuration of one device may be not accurate enough to reflect the body shape and/or the driving habit of the user 440. At this point, the configuration of another device may be obtained for updating the generated ergonomic model 430. In the implementations of the present invention, a third configuration of a third device that is equipped in the first vehicle may be obtained, where the third configuration is set by the user to meet the driving habit of the user. Further, the ergonomic model may be updated based on the obtained third configuration.

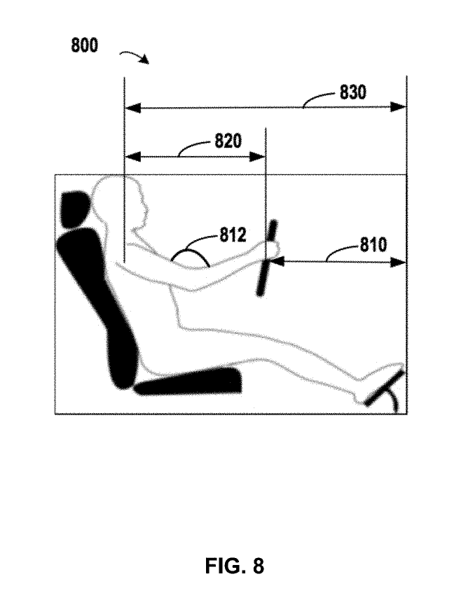

FIG. 8 depicts a diagram 800 for updating an ergonomic model for a user, in accordance with an embodiment of the present invention. In FIG. 8, the length of the arm may be directly determined based on positions of the backrest and the steering wheel. For example, the length 820 of the arm may be determined by a difference between the distance 830 between the backrest and the front of the vehicle 410 and the distance 810 between the steering wheel and the front of the vehicle 410. If the angle 812 at the elbow is considered, then the length of the arm may be determined in a more accurate manner based on the geometrical relationship among the lengths of the upper and lower arms as well as the angle 812.

In this implementation, as the length 820 of the arm determined according to FIG. 8 may be more accurate than the length of the arm estimated based on the length of the leg. The length of the arm in the ergonomic model 430 may be updated accordingly. In the above implementation, the configurations of more than one device may be used in generating the ergonomic model 430.

Once the ergonomic model 430 is generated based on the procedures as described in the preceding paragraphs, the second configuration of a second device that is equipped in a second vehicle 420 may be determined based on the generated ergonomic model 430. Reference will be made to FIG. 9 for details for determining the second configuration of the second device.

FIG. 9 depicts a diagram 900 for determining a configuration of a car seat that is equipped in another vehicle based on an ergonomic model for a user, in accordance with an embodiment of the present invention. From FIG. 9, it may be seen that the seat in the second vehicle 420 is much higher than the seat in the first vehicle 410. If the position of the seat in the second vehicle 420 is directly set according to the position of the seat in the first vehicle 410, the user 440 may possibly feel uncomfortable due to the differences of the height of the seat and the angle 912 at the knee. At this point, the ergonomic model 430 that is generated from the position of the seat in the first vehicle 420 may be used to determine the appropriate position of the seat in the second vehicle 420.

In the implementations of the present invention, in order to determine the second configuration of the second device, a second specification that specifies a coordinate system of the second vehicle 420 may be obtained. Further, the second configuration may be determined based on the generated ergonomic model 430 and the second specification.

Here, the second specification may be obtained from a guide from the manufacture of the second vehicle 420. In the example of determining the position of the seat, the coordinate system about the seat in the second vehicle 420 may be obtained. In one example, a position in the 3-dimension space, a size of the seat, the angle of the backrest of the seat, and other parameters such as a normal angle at the knee may be obtained. Based on the determined length of the leg in the ergonomic model 430 as well as the statistic in Table 1, the lengths of the thigh and the shank may be determined, respectively. Further, based on the lengths of the thigh and the shank, together with the normal angle 912, the position 910 of the seat may be determined according to a geometrical relationship therebetween.

Although the preceding paragraphs describe the implementations by taking determining the position of the seat in the second vehicle 420 as an example, the determining the configuration of other second devices may be implemented based on similar procedure as that described in the preceding paragraphs. For example, in order to determine the position of the steering wheel in the second vehicle 420, the length of the upper and lower arms and the normal angle at the elbow may be used.

In the implementations of the present invention, the second device may be adjusted based on the determined second configuration. In the above example, once the desired position of the seat in the second vehicle 420 is determined according to the implementations of the present invention, the position of the seat may be adjusted to the desired position in the second vehicle 420.

Sometimes, if the adjusted configuration of the second device cannot meet the user's driving habit, the user 440 may manually make further adjustment as a feedback. In the implementations of the present invention, in response to receiving from the user a feedback to the adjusted second device, the ergonomic model 430 may be modified based on the received feedback.

In the above example, if the user 440 feels that the position of the seat is uncomfortable, then the user 440 may further adjust the position of the seat by moving the seat back or forth to a new position according to his/her feeling. At this time, the further adjustment of the user 440 may be used for modifying the ergonomic model 430. For example, if the user 440 move the seat along a direction away from the front of the second vehicle 420, it may indicate that the position set according to the ergonomic model 430 is too near the front of the second vehicle 420 and thus the ergonomic model 430 may possibly modified based on the new position. Specifically, the length of the leg in the ergonomic model 430 may be increased so as to meet the driving habit of the user 440 in the second vehicle 420.

As the ergonomic model 430 is first generated based on the configurations of only one vehicle (such as the first vehicle 410), the generated ergonomic model 430 at the beginning may possibly not correct enough to reflect the driving habit of the user 440. With the above feedback from the user 440 in one or more second vehicles 420, the ergonomic model 430 may be modified gradually so as to meet the actual driving habit of the user 440. With the modified ergonomic model, more accurate configurations of other devices in other vehicles may be determined. In a desired situation, if the ergonomic model 430 is correct enough, the position of the seat in a new vehicle may be directly set to a desired position according to the ergonomic model 430, and there is no need for the user 440 to further adjust the position of the seat in the new vehicle manually.

In the implementations of the present invention, the device type of the first and second devices may comprise at least one of: a car seat, a steering wheel, a rearview mirror, a left mirror, a right mirror, a headrest, a safety belt, a car lamp, an air condition device, a multimedia device, or a navigation device.

Although the preceding paragraphs describe the detailed implementations for setting the positions of the car seat and the steering wheel, in other implementations, other devices in the second vehicle may be set accordingly. In one implementation of the present invention, the first and second devices may be of a same device type, and the device type may comprise at least one of: a car seat, a steering wheel, a rearview mirror, a left mirror, a right mirror, a headrest, a safety belt, a car lamp, an air condition device, a multimedia device, or a navigation device.

This implementation relates to a simple situation, where the ergonomic model 430 may only include the parameter(s) relating to the same device type. In an implementation of setting the position of the seat in the second vehicle 420, in a simplified situation, the ergonomic model 430 generated from the position of the seat in the first vehicle 410 may include only the length of the leg. When the user 440 changes to the second vehicle 420, the length of the leg may be used to determine the position of the seat for the second vehicle 420.

In the above implementation, the ergonomic model 430 is interpreted in a narrow way, where it may include parameters related to physical factors of the user's body, such that the positions of the seat, mirrors and other device may be adjusted according to the height and shape of the user. In other implementations, the ergonomic model 430 may be interpreted in a broad way. Specifically, the ergonomic model 430 may include other preference of the user such as the preferred driving environment in the vehicle, and other preferred configurations of electronic devices in the vehicle. With the broad interpretation, the driving environment may be adjusted according to the user's preference.

In another implementation, the configuration of the air condition in the first vehicle 410 may be obtained for generating the ergonomic model 430. If the air condition is set to 25 ⊐ in the first vehicle 410, then the air condition in the second vehicle 420 may also be set to 25 □ according to the ergonomic model 430. In still another implementation, the multimedia device in the second vehicle 420 may be set to a channel that is preferred by the user 440, and the navigation device in the second vehicle 420 may be set according to the preferred configuration of the user 440. For example, the multimedia device in the second vehicle 420 may be set to play favorite songs of the user 440, and the destination of the navigation device in the second vehicle 420 may be set to the address of the home for the user 440.

In one implementation of the present invention, the first and second devices may be of different device types. This implementation relates to a relative complex situation, where the ergonomic model 430 may be generated from the configuration of a first device, while the generated ergonomic model 430 may be used to set the configuration of a second device with a type other than that of the first device. Continuing the above example, based on the length of leg determined based on the position of the seat in the first vehicle 410, other ergonomic parameter(s) of the user 440 may be determined according to the proportions of human body as illustrated in Table 1. In one example, based on the length of the leg and “the length of the leg=0.426*the height,” the height of the user 440 may be determined. Further, other ergonomic parameter of the user 440 may be obtained based on the height.

In one implementation of the present disclosure, the height of the eye included in ergonomic model 430 may be determined, and then the position and orientation of each of the mirrors (such as the rearview mirror, the left mirror, and the right mirror) may be determined accordingly. In another implementation, the height of neck included in ergonomic model 430 the may be determined, and then the position of the headrest may be adjusted according to the height of the neck. In still another implementation, the preferred configurations of other devices (such as a safety belt, a car lamp, and so on) may be used as a base for generating the ergonomic model 430, and various type of devices in the second vehicle 420 may be adjusted according to the generated ergonomic model 430. In one example, the position of the shoulder may be determined based on the height of the user, and then the upper end of the safety belt may be adjusted according to the position of the user's shoulder. In another example, based on the position of the eyes, the orientation of the car lamp may be adjusted, such that the car lamp may illuminate the road in front of the car within an appropriate range.

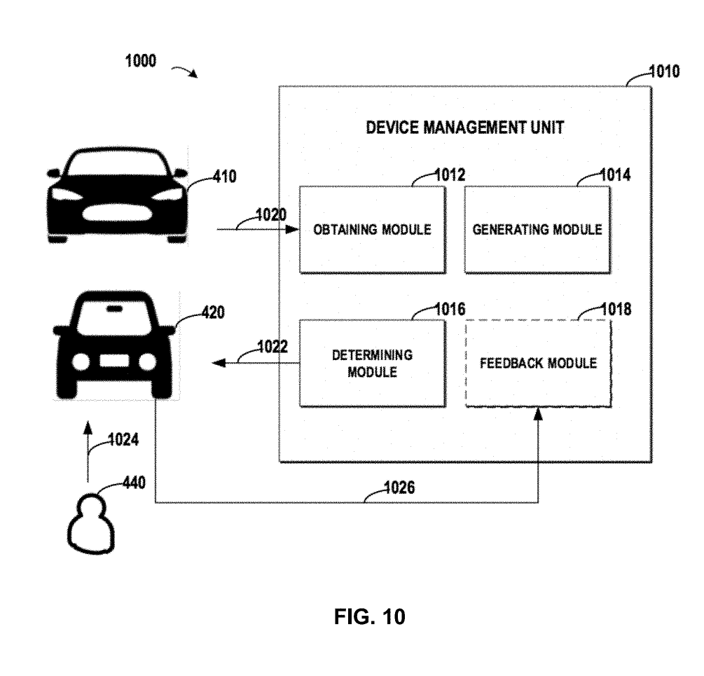

FIG. 10 depicts a diagram 1000 of a device management unit for managing a device in a vehicle based on ergonomic model for a user, in accordance with an embodiment of the present invention. According to FIG. 10, the device management unit 1010 may include an obtaining module 1012, a generating module 1014 and a determining module 1016. Here, the obtaining module 1012 may be configured to obtain 1020 a first configuration of a first device that is equipped in a first vehicle 410 (such as a car), the first configuration being set by a user of the first vehicle 410 so as to meet a driving habit of the user 440. The generating module 1014 may be configured to generate an ergonomic model 430 for the user 440 based on the obtained first configuration. The determining module 1016 may be configured to determine a second configuration of a second device that is equipped in a second vehicle 420 (such as a jeep) based on the generated ergonomic model 430.

When the user 440 changes to the second vehicle 420, if the configuration of the second device does not meet the driving habit of the user 440, then the user 440 may manually adjust the second device as a feedback. Further, the device management unit 1010 may include a feedback module 1018. The feedback module 1018 may be configured to receive the feedback 1026 to the adjusted second device from the user 440, and modify the ergonomic model 430 based on the received feedback.

It is to be understood that the device management unit 1010 may be achieved in a computing node that may obtain the first configuration from the first vehicle 410 and transmit the determined second configuration to the second vehicle 420. In one implementation, the device management unit 1010 may be achieved by a terminal device such as a mobile phone of the user 440. At this point, the mobile phone may connect to a control system of the first vehicle 410 via a Wi-Fi connection, a Bluetooth connection or another connection, and obtain the first configuration from the control system. Further, the ergonomic model 430 may be generated in the mobile phone, and then the determined second configuration may be transmitted to the control system of the second vehicle 420. In another implementation, the ergonomic model 430 may be generated at a server in a cloud environment, and various configurations may be determined for various types of vehicles at the server. When the user 440 enters into the second vehicle 420, he/she may download the corresponding configurations to the control system of second vehicle 420 so as to set the devices in the second vehicle 420 accordingly.

Although the preceding paragraphs of the present disclosure describe the implementations by taking the first and second vehicles 410 and 420 as examples, in a specific situation, the first vehicle 410 and the second vehicle 420 may be a same vehicle. In this specific situation, once the user 410 has adjusted position of the seat in the vehicle, the ergonomic model 430 may be generated based on the adjusted positon, where the height of the user 440 may be determined. In turns, other ergonomic parameters of the user 440 may be determined, and thus the ergonomic model 430 may be generated. Further, based on the generated ergonomic model 430, the configurations of other devices (such as the a steering wheel, a rearview mirror, a left mirror, a right mirror, a headrest, a safety belt, a car lamp, and the like) in the vehicle may be determined accordingly.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the C programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing a device in a vehicle, the method comprising:
obtaining a first configuration of a first device of a first vehicle, the first configuration being set by a user of the first vehicle, the first configuration meeting a driving habit of the user;
generating an ergonomic model for the user, based on the first configuration; and
determining a second configuration of a second device of a second vehicle based on the ergonomic model.

2. The computer-implemented method of claim 1, further comprising:
collecting one or more first parameters included in the first configuration by a sensor of the first vehicle; and
determining the ergonomic model based on the one or more first parameters.

3. The computer-implemented method of claim 2, further comprising:
obtaining a first specification that specifies a coordinate system of the first vehicle; and
determining the ergonomic model based on a comparison of the one or more first parameters and the first specification.

4. The computer-implemented method of claim 2, further comprising:
obtaining a third configuration of a third device of the first vehicle, the third configuration being set by the user to meet the driving habit of the user; and
updating the ergonomic model based on the third configuration.

5. The computer-implemented method of claim 1, further comprising:
obtaining a second specification that specifies a coordinate system of the second vehicle; and
determining the second configuration based on the ergonomic model and the second specification.

6. The computer-implemented method of claim 1, further comprising:
adjusting the second device based on the second configuration.

7. The computer-implemented method of claim 6, further comprising:
in response to receiving from the user a feedback to the second device, modifying the ergonomic model based on the feedback.

8. A computer program product for managing a device in a vehicle, the computer program product comprising a computer readable storage medium having program code embodied therewith, the program code executable to:
obtain a first configuration of a first device of a first vehicle, the first configuration being set by a user of the first vehicle, the first configuration meeting a driving habit of the user;
generate an ergonomic model for the user, based on the first configuration; and
determine a second configuration of a second device of a second vehicle based on the ergonomic model.

9. The computer program product of claim 8, further comprising the program code executable to:
collect one or more first parameters included in the first configuration by a sensor of the first vehicle; and
determine the ergonomic model based on the one or more first parameters.

10. The computer program product of claim 9, further comprising the program code executable to:
obtain a first specification that specifies a coordinate system of the first vehicle; and
determine the ergonomic model based on a comparison of the one or more first parameters and the first specification.

11. The computer program product of claim 9, further comprising the program code executable to:
obtain a third configuration of a third device of the first vehicle, the third configuration being set by the user to meet the driving habit of the user; and
update the ergonomic model based on the third configuration.

12. The computer program product of claim 8, further comprising the program code executable to:
obtain a second specification that specifies a coordinate system of the second vehicle; and
determine the second configuration based on the ergonomic model and the second specification.

13. The computer program product of claim 8, further comprising the program code executable to:
adjust the second device based on the second configuration.

14. The computer program product of claim 13, further comprising the program code executable to:
in response to receiving from the user a feedback to the second device, modify the ergonomic model based on the feedback.

15. A computer system for managing a device in a vehicle, the computer system comprising:
one or more processors, one or more computer readable tangible storage devices, and program instructions stored on at least one of the one or more computer readable tangible storage devices for execution by at least one of the one or more processors, the program instructions executable to:
obtain a first configuration of a first device of a first vehicle, the first configuration being set by a user of the first vehicle, the first configuration meeting a driving habit of the user;
generate an ergonomic model for the user, based on the first configuration; and
determine a second configuration of a second device of a second vehicle based on the ergonomic model.

16. The computer system of claim 15, further comprising the program instructions executable to:
collect one or more first parameters included in the first configuration by a sensor of the first vehicle; and
determine the ergonomic model based on the one or more first parameters.

17. The computer system of claim 16, further comprising the program instructions executable to:
obtain a first specification that specifies a coordinate system of the first vehicle; and
determine the ergonomic model based on a comparison of the one or more first parameters and the first specification.

18. The computer system of claim 16, further comprising the program instructions executable to:
obtain a third configuration of a third device of the first vehicle, the third configuration being set by the user to meet the driving habit of the user; and
update the ergonomic model based on the third configuration.

19. The computer system of claim 15, further comprising the program instructions executable to:
obtain a second specification that specifies a coordinate system of the second vehicle; and
determine the second configuration based on the ergonomic model and the second specification.

20. The computer system of claim 15, further comprising the program instructions executable to:
adjust the second device based on the second configuration; and
in response to receiving from the user a feedback to the second device, modify the ergonomic model based on the feedback.
